(19) United States
(12) Patent Application Publication
(10) Pub. No.: US 2020/0126057 A1
(43) Pub. Date: Apr. 23, 2020

(54) VEHICLE TERMINAL, AND SYSTEM AND METHOD FOR PROCESSING PAYMENT USING VEHICLE TERMINAL

(71) Applicants: HYUNDAI MOTOR COMPANY, Seoul (KR); KIA MOTORS CORPORATION, Seoul (KR)

(72) Inventors: Yun Joong PARK, Seoul (KR); Kyo Woong CHOO, Seoul (KR)

(21) Appl. No.: 16/397,175

(22) Filed: Apr. 29, 2019

(30) Foreign Application Priority Data
Oct. 23, 2018 (KR) 10-2018-0126936

(51) Int. Cl. G06Q 20/32; B67D 7/22

(52) U.S. Cl. CPC G06Q 20/327; B67D 7/227

(57) ABSTRACT

A vehicle terminal of a vehicle includes: a communication device configured to transmit or receive signal to or from a sever interworking with a service terminal of a filling station when a refueling event corresponding to a preset condition occurs; and a payment processing device configured to: construct a payment screen for a refueling charge of a corresponding filling station based on filling station guide information from the server when the refueling event occurs; and transmit payment information, which is input through the payment screen, to the server.

### CROSS-REFERENCE TO RELATED APPLICATION

This application is claims the benefit of priority to Korean Patent Application No. 10-2018-0126936, filed in the Korean Intellectual Property Office on Oct. 23, 2018, the entire contents of which are incorporated herein by reference.

### TECHNICAL FIELD

The present disclosure relates to a vehicle terminal, and a system and method for processing payment using the same.

### BACKGROUND

A conventional in-vehicle electronic payment system includes a vehicle terminal and a separate device for processing payment, where the vehicle terminal performs payment by interworking with the separate device in a beacon scheme or a phone connectivity scheme.

For example, when a vehicle enters a self-service station, a beacon which is installed at each gas stand recognizes the vehicle, and electronic payment is performed through interlocking between the vehicle terminal and the gas stand.

However, since each service terminal needs a beacon device, infrastructure development cost for electronic payment of vehicle terminals is high and it is difficult to maintain the infrastructure.

### SUMMARY

The present disclosure has been made to solve the above-mentioned problems occurring in the prior art while advantages achieved by the prior art are maintained intact.

An aspect of the present disclosure provides a vehicle terminal which is capable of improving convenience by transmitting payment information about a fuel charge through communication between a vehicle and a server in advance before the vehicle enters a filling station when a fueling event occurs in the vehicle and performing automatic payment process with previously transmitted information, and a system and a method for processing payment using the same.

An aspect of the present disclosure provides a vehicle terminal capable of increasing efficiency and reducing facility and operation costs by enabling electronic payment through a server without installing equipment for electronic payment at each gas stand of a filling station, and a system and a method for processing payment using the same.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a vehicle terminal of a vehicle includes: a communication device that transmits or receives a signal to or from a sever interworking with a service terminal of a filling station when a refueling event corresponding to a preset condition occurs; and a payment processing device that constructs a payment screen for a refueling charge of a corresponding filling station based on filling station guide information from the server when the refueling event occurs and transmits payment information, which is input through the payment screen, to the server.

The refueling event may occur when a remaining fuel amount, which is an amount of fuel currently available in the vehicle, is less than a first fuel amount which is a lowest criterion or a second fuel amount which is based on a refueling pattern of a user.

The payment information may include information about a charge to be paid for a refueling amount selected through the payment screen and payment card information.

The vehicle terminal may further include a controller that transmits state information of the vehicle to the server when the refueling event occurs and provide a guide screen based on the filling station guide information received from the server, based on the state information of the vehicle.

The state information of the vehicle may include at least one of identification information of the vehicle, remaining fuel amount information, current location (GPS) information, or destination information.

The filling station guide information may include at least one of a list of recommended filling stations, a filling station name, a basic charge, a remaining fuel amount of the vehicle, refueling charge information according to a refueling amount, or discount information.

The controller may transmit a filling station arrival notification signal to the server when the controller confirms that a filling station arrival notification event occurs, based on information received from a sensor of the vehicle and a navigation device.

The controller may determine whether the filling station arrival notification event occurs, based on a vehicle location and a filling station location confirmed by the navigation device and gear mode information confirmed by the sensor.

The vehicle terminal may further include an interface including a display that displays a guide screen and a payment screen.

According to another aspect of the present disclosure, a system for processing payment using the vehicle terminal of a vehicle includes: the vehicle terminal configured to process charge payment; a service terminal of a filling station; and a server that stores information about payment for a refueling charge of the filling station, which is received from the vehicle terminal when a refueling event corresponding to a preset condition occurs and processes refueling charge payment of the vehicle based on the stored payment information when a filling station arrival notification signal is received from the vehicle terminal.

The server may provide filling station guide information to the vehicle terminal based on state information of the vehicle received from the vehicle terminal when the refueling event occurs.

The filling station guide information may include at least one of a list of recommended filling stations, a filling station name, a basic charge, a remaining fuel amount of the vehicle, refueling charge information according to a refueling amount, or discount information.

The server may recognize vehicle information based on information previously registered in a customer database (DB) and generate the filling station guide information based on filling station payment history stored corresponding to the recognized vehicle.

The payment information may include information about a charge to be paid for a refueling amount selected through the payment screen and payment card information.

The server may approve payment for the refueling charge of the vehicle by confirming a refueling completion state of the vehicle from the service terminal when the payment for the refueling charge of the vehicle is performed.

According to still another aspect of the present disclosure, a method of processing payment by a payment processing system including a vehicle terminal of a vehicle, a service terminal, and a server includes steps of: transmitting, by the vehicle terminal, vehicle state information to the server when a refueling event corresponding to a preset condition occurs; providing, by the server, filling station guide information to the vehicle terminal based on the vehicle state information; storing, by the server, payment information for a refueling charge of a filling station received from the vehicle terminal, based on the filling station guide information; and processing, by the server, payment for the refueling charge of the vehicle based on the stored payment information when a filling station arrival notification signal is received from the vehicle terminal.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a payment processing system using a vehicle terminal according to an embodiment of the present disclosure;

FIG. 2 is a view illustrating a configuration of a vehicle terminal according to an embodiment of the present disclosure;

FIG. 3 is a view illustrating a configuration of a server according to an embodiment of the present disclosure;

FIG. 4 is a flowchart illustrating an operation of a method of processing payment using a vehicle terminal according to a first embodiment of the present disclosure;

FIG. 5 is a flowchart illustrating the detailed operations of operation of FIG. 4;

FIG. 6 is a flowchart illustrating a method of processing payment using a vehicle terminal according to a second embodiment of the present disclosure;

FIGS. 7A and 7B are views illustrating examples of a refueling guide screen according to an embodiment of the present disclosure;

FIGS. 8A and 8B are views illustrating an example of another payment screen according to an embodiment of the present disclosure;

FIG. 9 is a flowchart illustrating an operation of a payment processing method using a vehicle terminal according to a third embodiment of the present disclosure;

FIG. 10 is a view illustrating an example of a payment completion screen according to an embodiment of the present disclosure;

FIG. 11 is a flowchart illustrating an operation of a method of processing payment using a vehicle terminal according to a fourth embodiment of the present disclosure; and

FIG. 12 is a block diagram illustrating a computer system according to an embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known features or functions will be ruled out in order not to unnecessarily obscure the gist of the present disclosure.

In describing the components of the present disclosure, terms like first, second, “A”, “B”, (a), and (b) may be used. These terms are intended solely to distinguish one component from another, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

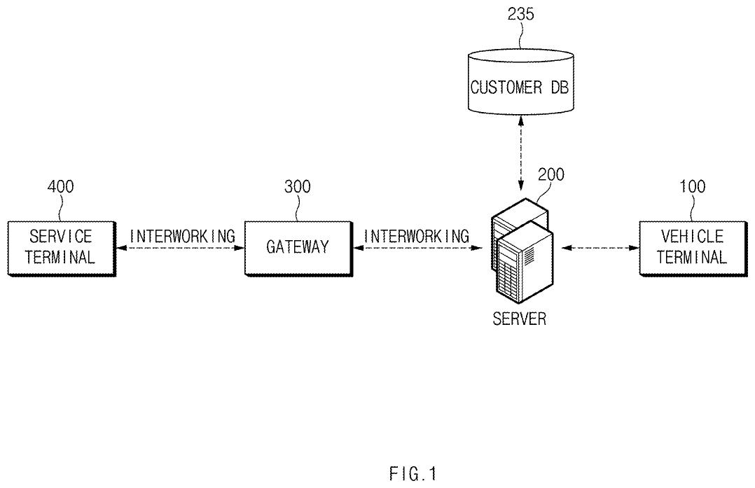

FIG. 1 is a view illustrating a payment processing system using a vehicle terminal according to an embodiment of the present disclosure.

According to an embodiment of the present disclosure, a payment processing system using a vehicle terminal (hereinafter, referred to as “payment processing system”) may include a vehicle terminal 100, a server 200, a gateway 300, and a service terminal 400.

The vehicle terminal 100, which is a target terminal using a service, has a payment processing module that performs the electronic payment of a service fee. In this case, the payment processing module pays the service fee by using the information about payment means previously registered or input by the user when a service is used.

For example, the vehicle terminal 100 transmits the state information of the vehicle to the server 200 when a fueling event corresponding to a preset condition occurs. At this time, the vehicle terminal 100 can perform settlement of gasoline charges based on the filling station information provided from the server 200 according to the state information of the vehicle

In this case, the vehicle terminal 100 may settle the fuel charge through communication with the server 200 in advance for the filling station selected as a target before the vehicle enters the filling station.

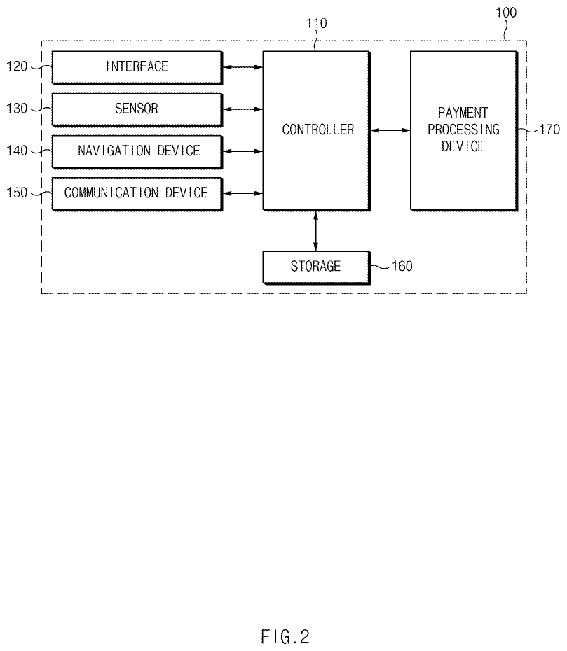

Thus, a description of the details of the vehicle terminal 100 refers to the embodiment of FIG. 2.

The server 200 may recognize information about a corresponding vehicle based on the information received from the vehicle terminal 100 where a refueling event is occurred, and may confirm the payment history of the recognized vehicle to provide filling station guide information. When a payment request is received from the vehicle terminal 100 together with the refueling information and the payment information based on the filling station guide information, the server 200 approves the payment for the refueling charge by using the refueling information and payment information received.

While the server 200 stores the received payment information and stands by when the vehicle that requested the payment of the refueling charge is before entering the filling station, when it is confirmed that the vehicle enters the filling station of the vehicle, the server 200 may automatically approve the payment of the refueling charge by using the previously stored payment information.

In this case, the server 200 may interwork with an associate company for proving a service to the vehicle terminal 100, for example, the service terminal 400 of a filling station, through the gateway 300 to confirm a charge for a service used by the vehicle terminal 100, and may inform the vehicle terminal 100 of the service fee. In addition, the server 200 may provide the payment information of the vehicle terminal 100 to the service terminal 400 through the gateway 300.

In addition, the server 200 registers information previously registered by a customer (user) using the vehicle terminal 100 in a customer database (DB) 235 and processes the charge payment requested by the vehicle terminal 100 by using the customer information registered in the customer DB 235. The server 200 may store the payment history information of a filling station in the customer DB 235 for each customer.

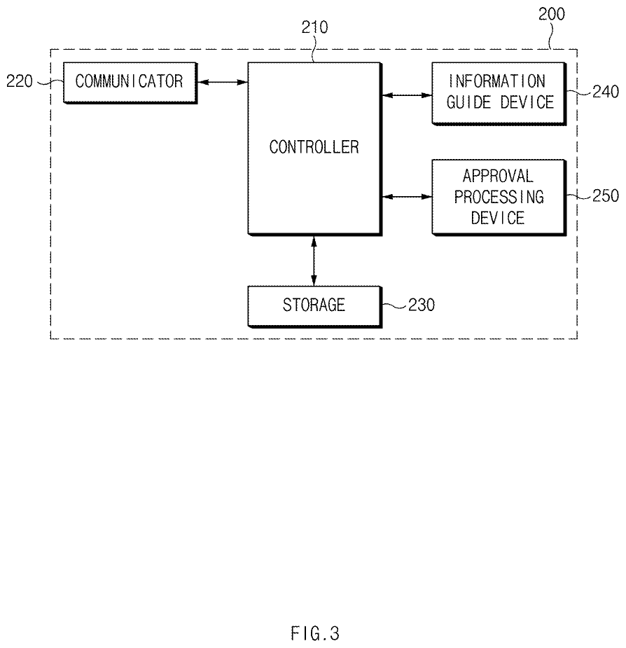

The details of the server 200 will be described with reference to the embodiment of FIG. 3.

The service terminal 400 may include at least one of a gas stand or a point-of-sale (POS) terminal arranged at a filling station. In this case, the service terminal 400 interworks with the server 200 through the gateway 300 to share information.

FIG. 2 is a view illustrating a configuration of a vehicle terminal according to an embodiment of the present disclosure.

Referring to FIG. 2, the vehicle terminal 100 may include a controller 110, an interface 120, a sensor 130, a navigation device 140, a communication device 150, storage 160, and a payment processing device 170. In this case, the controller 110 and the payment processing device 170 of the vehicle terminal 100 according to an embodiment may be implemented with at least one processor or each of them itself may be a processor.

The controller 110 may process signals transmitted between components of the vehicle terminal 100.

The interface 120 may include input means for receiving a control command from a user and output means for outputting an operation state of the vehicle terminal 100, a result, and the like.

In this case, the input means may include a key button, and may include a mouse, a joystick, a jog shuttle, a stylus pen, and the like. In addition, the input means may include a soft key implemented on a display.

The output means may include a display, and may include voice output means such as a speaker. In this case, when a touch sensor such as a touch film, a touch sheet, a touch pad, or the like is provided on the display, the display may operate as a touch screen, and the input means and the output means may be implemented in an integrated type.

In this case, the display may include at least one of a liquid crystal display (LCD), a thin film transistor liquid crystal display (TFT LCD), an organic light-emitting diode (OLED), a flexible display, a field emission display (FED), or a three-dimensional display (3D) display.

The sensor 130 is arranged in the vehicle and detects at least one piece of vehicle information. In this case, a plurality of sensors 130 may be provided. For example, the sensor 130 may include a sensor that detects an amount of fuel remaining in the vehicle. In addition, the sensor 130 may further include a sensor for detecting gear range information of the vehicle. In addition, the sensor 130 may further include a sensor for detecting whether the vehicle is turned on or off.

The navigation device 140 receives GPS signals received from a plurality of satellites to search for a position and to inform of the detected position.

In addition, the navigation device 140 may provide surrounding information registered in a map based on a current location. For example, the navigation device 140 may provide the location information of the filling station based on the current location. The navigation device 140 may compare the current location of the vehicle terminal 100 with the location of the filling station to determine whether the vehicle enters the filling station.

The communication device 150 may include a communication module that supports communication interfaces with automotive electronics and/or control units provided in the vehicle. As an example, the communication module may receive vehicle information from the sensor 130 provided in the vehicle. In addition, the communication module may receive the location information of the vehicle, the filling station information, and the like from the navigation device 140.

In this case, the communication module may include a module for supporting vehicle network communication such as controller area network (CAN) communication, local interconnect network (LIN) communication, flex-ray communication, or the like.

In addition, the communication device 150 may further include a communication module that supports a communication interface with the server 200. As an example, the communication module may include a module for wireless Internet access or a module for short range communication. In this case, the wireless Internet technology may include wireless LAN (MILAN), wireless broadband (Wibro), Wi-Fi, world interoperability for microwave access (WiMAX), and the like. The short range communication may include Bluetooth, ZigBee, ultra-wideband (UWB), radio frequency identification (RFID), infrared data association (IrDA), and the like.

The storage 160 may store data and/or an algorithm necessary for operating the vehicle terminal 100.

The storage 160 may store information received from the sensor 130 and/or the navigation device 140 through the communication device 150 and may store information received from the server 200.

In addition, the storage 160 may store information about an event, and store information about previously registered payment means. In addition, the storage 160 may store a command and/or an algorithm for configuring a guide screen and/or a payment screen, determining whether to make a payment, and performing payment processing based on the information input through the payment screen.

In this case, the storage 160 may include a storage medium such as a random access memory (RAM), a static random access memory (SRAM), a read-only memory (ROM), a programmable read-only memory (PROM), an electrically erasable programmable read-only memory (EEPROM), or the like.

The controller 110 determines whether a refueling event occurs, based on the vehicle information detected by the sensor 130 when the vehicle is turned on.

In this case, when a remaining fuel amount detected by the sensor 130 is less than a first fuel amount which is the lowest criterion (when a warning lamp is turned on), the refueling event may occur. In addition, the refueling event may occur even when the remaining fuel amount detected by the sensor 130 is larger than or equal to the first fuel amount, but is less than a second fuel amount (refueling pattern based fuel amount) corresponding to a normal refueling pattern of a user.

The controller 110 transmits the state information of the vehicle to the server 200 through the communication device 150 when it is confirmed that the refueling event occurs. In this case, the state information of the vehicle may include identification information of the vehicle, remaining fuel amount information, current location (GPS) information, and/or destination information.

When the filling station guide information according to the state information of the vehicle is received from the server 200, the controller 110 may construct a guide screen corresponding to the received filling station guide information and display the guide screen on the display. In this case, the filling station guide information may include a list of recommended filling stations, a filling station name, a basic charge, a remaining fuel amount of the vehicle, refueling charge information according to fueling amount, discount information, and the like.

In addition, the controller 110 may determine whether a filling station arrival event occurs, based on the information received from the sensor 130 and the navigation device 140.

In this case, the controller 110 determines whether the vehicle location confirmed from the navigation device 140 corresponds to the location of the filling station or is within a specified distance from the filling station. Further, the controller 110 determines whether the gear position is shifted into mode ‘P’ based on the information received from the sensor 130. The controller 110 may determine that a filling station arrival event occurs when the mode ‘P’ is selected at the filling station location at which the vehicle is located.

The controller 110 transmits filling station arrival notification information to the server 200 when the filling station arrival event occurs.

The payment processing device 170 may construct a payment screen in response to a request of a user and display the payment screen on the display.

In this case, the payment processing device 170 may configure the payment screen based on the information about the filling station selected from the recommended filling station list shown in the guide screen and the vehicle state information.

When the refueling information and the payment information are input from the user through the payment screen, the payment processing device 170 calculates the charge based on the input information, and transmits a payment request signal for the refueling charge of the corresponding filling station together with the input information to the server 200. When receiving approval completion information from the server 200, the payment processing device 170 constructs a payment completion screen based on the received approval completion information and displays the payment completion screen on the display.

FIG. 3 is a view illustrating a configuration of a server according to an embodiment of the present disclosure.

Referring to FIG. 3, the server 200 may include a controller 210, a communication device 220, storage 230, an information guide device 240, and an approval processing device 250. The controller 210, the information guide device 240, and the approval processing device 250 of the server 200 according to the present embodiment may be implemented as at least one processor

The controller 210 may process signals transmitted between components of the server 200.

The communication device 220 may include a communication module that supports a communication interface with the vehicle terminal 100. In addition, the communication device 220 may include a communication module that supports a communication interface with the service terminal 400. As an example, the communication module may include a module for wireless Internet access or a module for short range communication. In this case, the wireless Internet technology may include wireless LAN (MILAN), wireless broadband (Wibro), Wi-Fi, world interoperability for microwave access (WiMAX), and the like. The short range communication may include Bluetooth, ZigBee, ultra-wideband (UWB), radio frequency identification (RFID), infrared data association (IrDA), and the like.

The storage 230 may store data and/or an algorithm necessary for operating the server 200. In this case, the storage 230 may include the customer DB 235 therein. The storage 230 may be provided separately from the customer DB 235.

In this case, the storage 230 may include a storage medium such as a random access memory (RAM), a static random access memory (SRAM), a read-only memory (ROM), a programmable read-only memory (PROM), an electrically erasable programmable read-only memory (EEPROM), or the like.

When the state information of the vehicle is received from the vehicle terminal 100, the controller 210 recognizes the corresponding vehicle information from the customer DB 235, and confirms filling station using information and payment history stored corresponding to the recognized vehicle.

The information guide device 240 generates filling station guide information including a list of recommended filling stations and information about the recommended filling stations based on the filling station using information and payment history, and transmits the generated filling station guide information to the vehicle terminal 100. When the payment history of a filling station does not exist or the recommended filling station is located at a specified distance or more from the location of the vehicle, the information guide device 240 may provide the guide information on a filling station as a recommended filling station, which is located at a short distance therefrom on the moving route.

In this case, the information guide device 240 may check the basic charge for each fuel type of the filling station, and may calculate and guide for refueling charges for each amount of fuel based on the fuel type and the remaining fuel amount of the vehicle. In addition, the information guide device 240 may check the average refueling amount of the vehicle based on the filling station using information of the corresponding vehicle registered in the customer DB 235, and may calculate and guide the refueling charge based on the average refueling amount.

When a filling station payment request is received from the vehicle terminal 100, the approval processing device 250 uses the payment information, payment authentication information, membership information, and/or point information received from the vehicle terminal 100 to perform the payment. In this case, the controller 210 transmits refueling start request information to the service terminal 400 of the filling station when the approval processing device 250 proceeds the payment.

In addition, the approval processing device 250 approves the payment when the service terminal 400 confirms refueling completion information of the corresponding vehicle. The approval processing device 250 transmits payment approval completion information to the vehicle terminal 100 when the payment approval processing for the refueling charge of the corresponding vehicle is completed.

When a filling station arrival notification signal is not received from the vehicle terminal within a specified time after the payment information received from the vehicle terminal is stored, the controller 210 may delete the previously stored payment information.

In addition, when the filling station arrival notification signal is received from the vehicle terminal after the payment information of the vehicle terminal is deleted, the controller 210 may request the vehicle terminal for payment information through a background and receive the payment information from the vehicle terminal again.

The vehicle terminal 100 and/or the server 200 according to an embodiment, which operates as described above, may be implemented in the form of an independent hardware device including a memory and a processor for processing each operation, or may be operated as configurations included in another hardware device such as a microprocessor or a general purpose computer system.

The operation of the payment processing system using the vehicle terminal according to the present disclosure configured as described above will be described in more detail as follows.

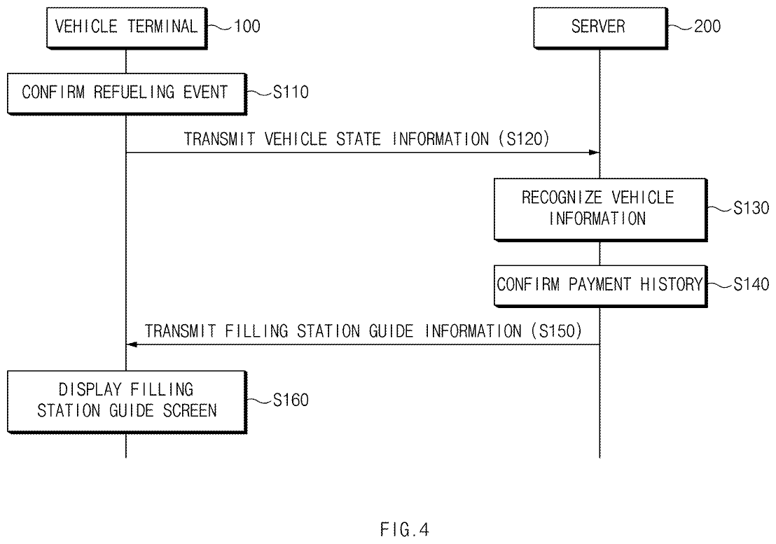

FIG. 4 is a flowchart illustrating an operation of a method of processing payment using a vehicle terminal according to a first embodiment of the present disclosure.

Referring to FIG. 4, when it is confirmed in operation S110 that a predefined refueling event occurs, the vehicle terminal 100 transmits, to the server 200, the state information of the vehicle including identification information, remaining fuel amount information, current location (GPS) information, and/or destination information of the vehicle in operation S120.

In operation S130, the server 200 recognizes the vehicle information from the information received in operation S120, and in operation S140, confirms the stored payment history for the recognized vehicle. In operation S140, the server 200 confirms the filling station payment history of the corresponding vehicle.

In operation S150, the server 200 generates the filling station guide information based on the filling station payment history confirmed in operation S140 and the state information of the vehicle received in operation S120 and transmits the generated filling station guide information to the vehicle terminal 100 in operation S150.

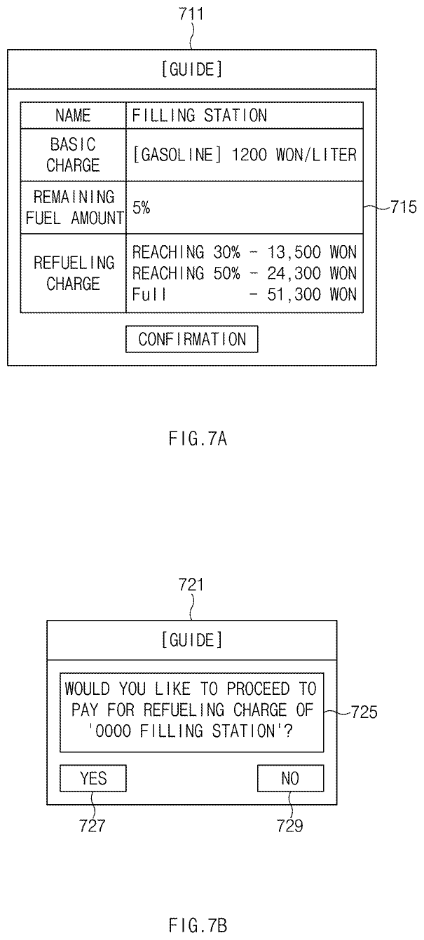

Thus, in operation S160, the vehicle terminal 100 forms a refueling guide screen based on the filling station guide information received in operation S150 and displays the fueling guide screen on the display. In this case, an embodiment of the refueling guide screen is shown in FIG. 7A.

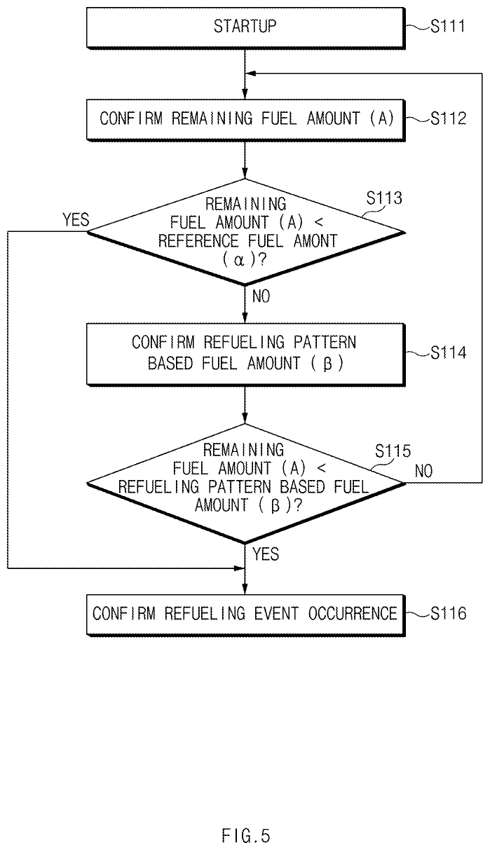

FIG. 5 is a flowchart illustrating the detailed operations of operation S110 of FIG. 4.

Referring to FIG. 5, when the vehicle terminal 100 is turned on in operation S111, the vehicle terminal 100 checks the remaining fuel amount ‘A’ of the vehicle through the sensor 130 in operation S112. In this case, when the remaining fuel amount ‘A’ checked in operation S112 is less than reference fuel amount ‘α’ (when the warning light turns on), in operation S116, the vehicle terminal 100 may determine that the refueling event occurs.

When the remaining fuel amount ‘A’ checked in operations S112 and S113 is equal to or greater than the reference fuel amount ‘α’, in operation S114, the vehicle terminal 100 confirms the refueling pattern based fuel amount ‘β’ of the vehicle. In this case, when the remaining fuel amount ‘A’ is less than the refueling pattern based fuel amount ‘β’ confirmed in operation S114 in operation S115, the vehicle terminal 100 may confirm in operation S116 that the refueling event occurs.

When it is confirmed that the remaining fuel amount ‘A’ is equal to or greater than the refueling pattern based fuel amount ‘β’ in operation S115, the vehicle terminal 100 may determine that the refueling event does not occur.

In this case, the vehicle terminal 100 may perform operations S112 to S116 in real time or every time period and determine whether a refueling event occurs.

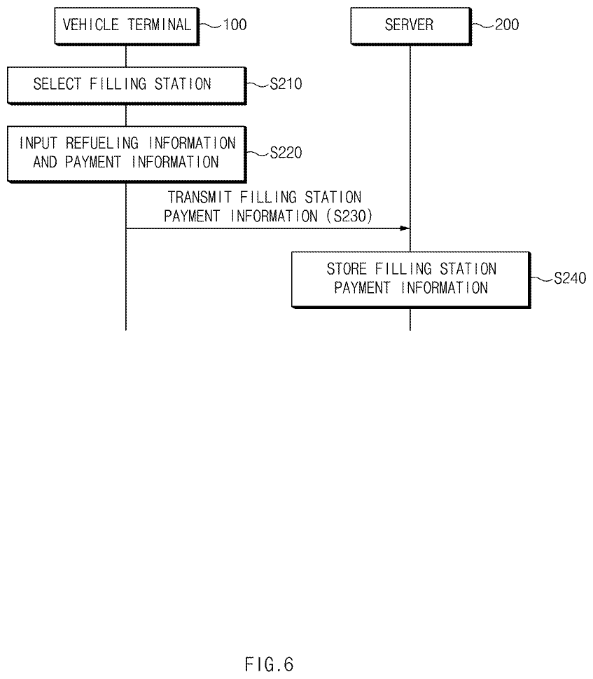

FIG. 6 is a flowchart illustrating a method of processing payment using a vehicle terminal according to a second embodiment of the present disclosure.

Referring to FIG. 6, when a filling station for refueling charge payment is selected through the refueling guide screen in operation S210 and the refueling information and the payment information are input through the payment screen by the user in operation S220, the vehicle terminal 100 transmits the filling station payment request including the refueling information and the payment information input through operation S220 to the server 200 in operation S230.

Thus, in operation S240, the server 200 stores the filling station payment information received in operation S230 corresponding to the corresponding vehicle information. Thereafter, the server 200 waits for payment until a filling station arrival notification is received from the corresponding vehicle.

FIGS. 7A and 7B are views illustrating examples of a refueling guide screen according to an embodiment of the present disclosure.

First, referring to FIG. 7A, the refueling guide screen 711 may include information 715 about a recommended filling station. In this case, the information 715 about the recommended filling station may include information about the name of the corresponding filling station (e.g., 0000 filling station), the basic charge (e.g., [gasoline] 1200 won/liter), and the remaining fuel amount (e.g., 5%), the refueling charge (e.g., when reaching 30%: 13,500 won/when reaching 50%: 24,300 won/Full: 51,300 won).

After displaying the refueling guide screen 711 as shown in FIG. 7A, the vehicle terminal 100 may display a guide screen 721 including a message 725 for inquiring whether to proceed the charge payment for the recommended filling station included in the refueling guide screen as shown in FIG. 7B,

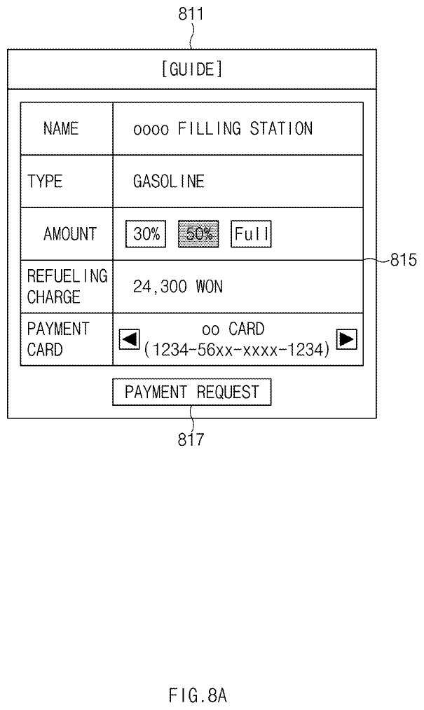

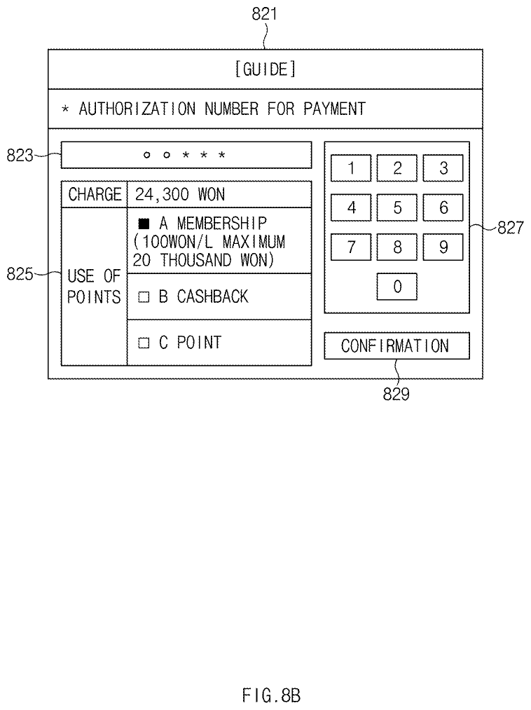

When a Yes' button 727 of the guide screen 721 is selected by the user, the vehicle terminal 100 forms the payment screen of FIGS. 8A and 8B and displays the payment screen on the display. When a NO′ button 729 is selected, the guide is terminated.

FIGS. 8A and 8B are views illustrating an example of another payment screen according to an embodiment of the present disclosure.

As shown in FIG. 8A, the vehicle terminal 100 forms a payment screen 811 based on the filling station information selected through the guide screen of FIGS. 7A and 7B and displays payment screen 811 on the display. In this case, the payment screen 811 may include a message 815 about a filling station name, a fuel type, a refueling amount, a charge to be paid for a selected refueling amount, and a payment card.

In this case, when a payment request button 817 on the payment screen 811 is operated by the user, as shown in FIG. 8B, the payment authentication screen 821 is constructed and displayed on the display.

As shown in FIG. 8B, the payment authentication screen 821 may include an authentication information input window 823 for performing payment using a user's card, a confirmation window 825 for confirming membership and/or point information, and a key input window 735.

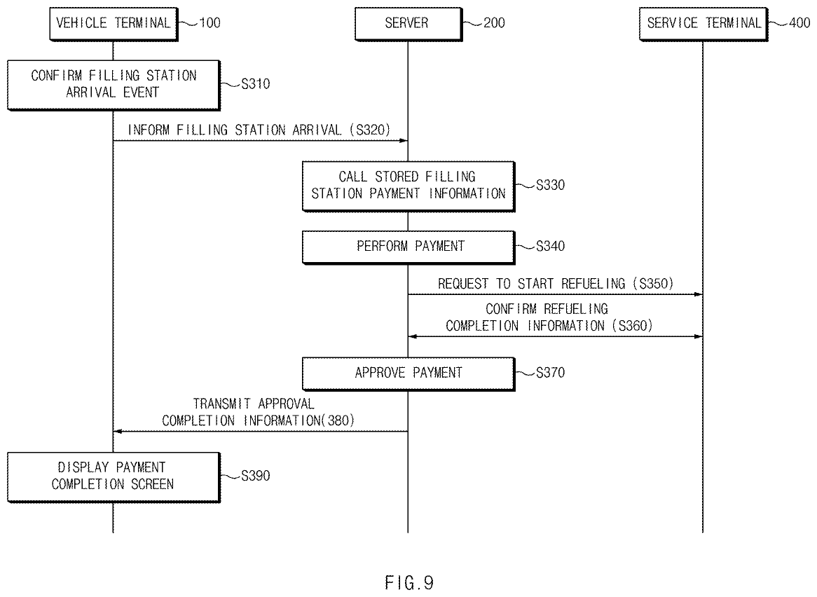

FIG. 9 is a flowchart illustrating an operation of a payment processing method using a vehicle terminal according to a third embodiment of the present disclosure. FIG. 9 shows an example in which a filling station arrival notification event occurs after the filling station payment information is stored in the server of FIG. 6.

Referring to FIG. 9, when it is determined that a filling station arrival event occurs in operation S310, the vehicle terminal 100 transmits a filling station arrival notification signal to the server 200 in operation S320.

In this case, when it is determined that the vehicle enters mode ‘P’ at the filling station location, based on the gear mode information detected from the sensor 130 and the vehicle location received from the navigation device 140, the vehicle terminal 100 may determine that a filling station arrival event occurs.

When the filling station arrival notification signal is received as in operation S320 after the filling station payment information is stored in operation S240 of FIG. 6, the server 200 calls out the previously stored filling station payment information in operation S330 and automatically performs the payment in operation S340.

When the payment for the refueling charge of the vehicle is performed, in operation S350, the server 200 transmits a signal of requesting refueling start to the service terminal 400 of the corresponding filling station. Thus, the service terminal 400 may guide the vehicle terminal 100 to start fueling. In addition, the service terminal 400 may confirm the progress of refueling of the vehicle. In this case, the server 200 checks the refueling state of the vehicle from the service terminal 400, and when the refueling completion information is confirmed in operation S360, the server 200 approves the payment for the refueling charge of the vehicle in operation S370. In operation S380, the server 200 transmits the payment approval completion information in operation S370 to the vehicle terminal 100.

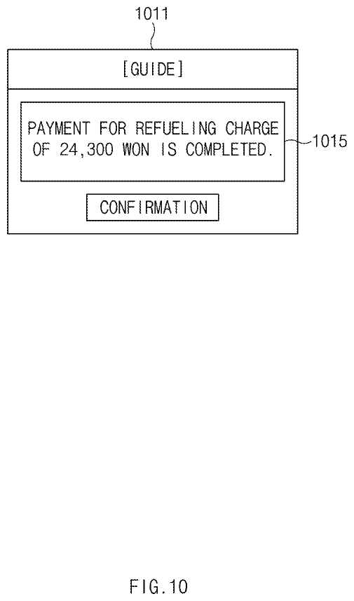

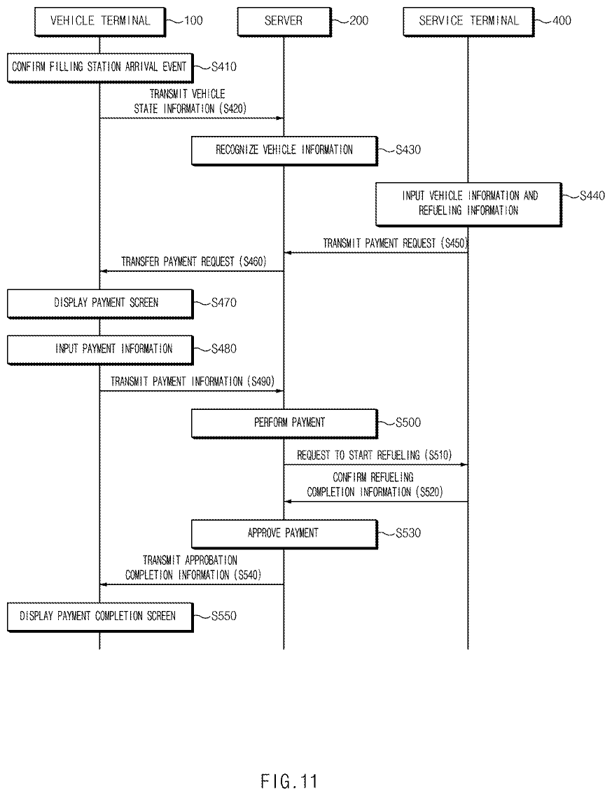

Then, the vehicle terminal 100 forms a payment completion screen based on the payment approval completion information received in the process of operation S380 and displays it on the display (S390). An example of the payment completion screen will be described with reference to FIG. 10.

Referring to FIG. 10, a payment completion screen 1011 may include a message 1015 of “Payment of refueling charge of 24,300 won is completed.”

FIG. 11 is a flowchart illustrating an operation of a method of processing payment using a vehicle terminal according to a fourth embodiment of the present disclosure.

FIG. 11 illustrates an embodiment where a filling station arrival notification event occurs in a state where payment information is not input after the refueling guide screen in operation S160 of FIG. 4, or a refueling event does not occur previously.

Referring to FIG. 11, when it is determined in operation S410 that the filling station arrival event occurs, the vehicle terminal 100 transmits a filling station arrival notification signal to the server 200 in operation S420.

In this case, the server 200 does not store the filling station settlement information from the vehicle terminal 100. Accordingly, when the filling station arrival notification signal is received in operation S420, the server 200 recognizes the vehicle information based on the information received from the vehicle terminal 100 in operation S430. Thereafter, when vehicle information and the refueling information are input to the service terminal 400 of the filling station and the payment request signal for the refueling charge of the corresponding vehicle is transmitted from the service terminal 400 to the server 200 in operation S450, the server 200 transmits the payment request signal received in operation S450 to the vehicle terminal 100 in operation S460.

Accordingly, the vehicle terminal 100 forms a payment screen in response to the payment request received in operation S460 and displays the payment screen on the display in operation S470.

When the payment information is inputted by the user through the payment screen in operation S480, in operation S490, the vehicle terminal 100 transmits the payment information inputted in operation S480 to the server 200 to request payment.

Then, in operation S500, the server 200 performs the payment for the refueling charge of the vehicle based on the payment information received in operation S490.

In operation S510, the server 200 transmits a signal of requesting fueling start to the service terminal 400 of the corresponding filling station. Thus, the service terminal 400 may guide the vehicle terminal 100 to start fueling. In addition, the service terminal 400 may confirm the progress of refueling of the vehicle. In this case, the server 200 checks the refueling state of the vehicle from the service terminal 400, and when the refueling completion information is confirmed in operation S520, the server 200 approves the payment for the refueling charge of the vehicle in operation S530. The server 200 transmits the payment approval completion information in operation S530 to the vehicle terminal 100 in operation S540.

Thus, the vehicle terminal 100 forms a payment completion screen based on the payment approval completion information received in operation S540 and displays the payment completion screen on the display in operation S550.

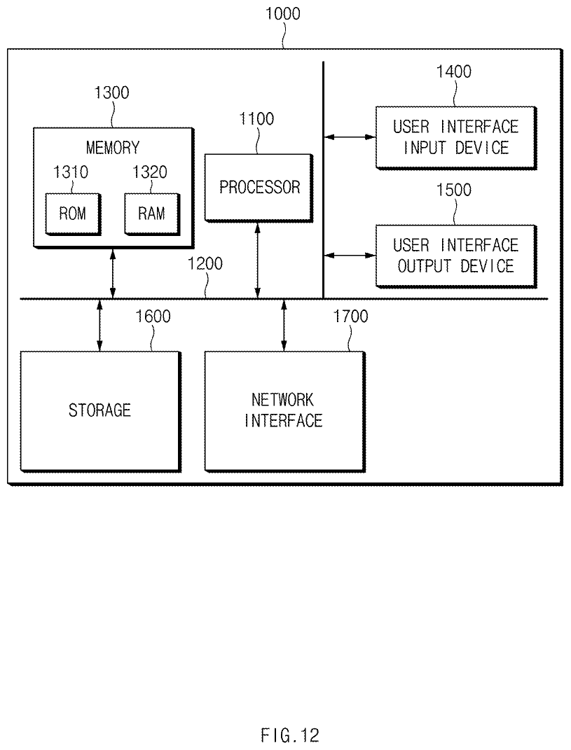

FIG. 12 is a block diagram illustrating a computer system according to an embodiment of the present disclosure.

Referring to FIG. 12, a computing system 1000 may include at least one processor 1100, a memory 1300, a user interface input device 1400, a user interface output device 1500, storage 1600, and a network interface 1700, which are connected to each other through a bus 1200.

The processor 1100 may be a central processing unit (CPU) or a semiconductor device which performs processing for instructions stored in the memory device 1300 and/or the storage 1600. The memory 1300 and the storage 1600 may include various types of volatile or non-volatile storage media. For example, the memory 1300 may include a read only memory (ROM) and a random access memory (RAM).

The operations of a method or algorithm described in connection with the embodiments disclosed herein may be embodied directly in hardware, in a software module executed by the processor 1100, or in a combination of the two. The software module may reside in a storage medium (that is, the memory 1300 and/or the storage 1600) such as a random access memory (RAM), a flash memory, a read only memory (ROM), an erasable programmable ROM (EPROM), an electrically erasable programmable ROM (EEPROM), registers, hard disk, a removable disk, a compact disc-ROM (CD-ROM), etc. An exemplary storage medium is coupled to the processor 1100 such that the processor 1100 may read information from, and write information to, the storage medium. Alternatively, the storage medium may be integrated into the processor 1100. The processor and the storage medium may reside in an ASIC. The ASIC may reside within a user terminal. Alternatively, the processor and the storage medium may reside in the user terminal as individual components.

According to the embodiments, it is possible to improve convenience by transmitting payment information about a fuel charge through communication between a vehicle and a server in advance before the vehicle enters a filling station when a refueling event occurs in the vehicle and performing automatic payment process with previously transmitted information.

In addition, according to the embodiment, it is possible to increase efficiency and reducing facility and operation costs by enabling electronic payment through a server without installing equipment for electronic payment at each gas stand of a filling station.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle terminal of a vehicle comprising:
a communication device configured to transmit or receive signal to or from a sever interworking with a service terminal of a filling station when a refueling event corresponding to a preset condition occurs; and
a payment processing device configured to:
construct a payment screen for a refueling charge of a corresponding filling station based on filling station guide information from the server when the refueling event occurs; and
transmit payment information, which is input through the payment screen, to the server.

2. The vehicle terminal of claim 1, wherein the refueling event occurs when a remaining fuel amount, which is an amount of fuel currently available in the vehicle, is less than a first fuel amount which is a lowest criterion or a second fuel amount which is based on a refueling pattern of a user.

3. The vehicle terminal of claim 1, wherein the payment information includes information about the refueling charge to be paid for a refueling amount selected through the payment screen and payment card information.

4. The vehicle terminal of claim 1, further comprising a controller configured to:
transmit vehicle state information to the server when the refueling event occurs; and
provide a guide screen regarding the filling station guide information received from the server based on the vehicle state information of the vehicle.

5. The vehicle terminal of claim 4, wherein the vehicle state information includes at least one of identification information of the vehicle, remaining fuel amount information, current location (GPS) information, or destination information.

6. The vehicle terminal of claim 4, wherein the filling station guide information includes at least one of a list of recommended filling stations, a filling station name, a basic charge, a remaining fuel amount of the vehicle, refueling charge information according to a refueling amount, or discount information.

7. The vehicle terminal of claim 4, wherein the controller is configured to transmit a filling station arrival notification signal to the server when the controller determines that a filling station arrival notification event occurs, based on information received from a sensor of the vehicle and a navigation device.

8. The vehicle terminal of claim 7, wherein the controller is configured to determine whether the filling station arrival notification event occurs, based on a vehicle location and a filling station location determined by the navigation device and gear mode information determined by the sensor.

9. The vehicle terminal of claim 1, further comprising:
an interface including a display configured to display a guide screen and the payment screen.

10. A system for processing payment using a vehicle terminal of a vehicle, the system comprising:
the vehicle terminal configured to process charge payment;
a service terminal of a filling station; and
a server configured to:
store information about payment for a refueling charge of the filling station, which is received from the vehicle terminal when a refueling event corresponding to a preset condition occurs; and
process refueling charge payment of the vehicle based on the stored payment information when a filling station arrival notification signal is received from the vehicle terminal.

11. The system of claim 10, wherein the server is configured to provide filling station guide information to the vehicle terminal based on vehicle state information received from the vehicle terminal when the refueling event occurs.

12. The system of claim 11, wherein the filling station guide information includes at least one of a list of recommended filling stations, a filling station name, a basic charge, a remaining fuel amount, which is an amount of fuel currently available in the vehicle, refueling charge information according to a refueling amount, or discount information.

13. The system of claim 11, wherein the server is configured to:
recognize vehicle information based on information previously registered in a customer database; and
generate the filling station guide information based on filling station payment history stored corresponding to the recognized vehicle.

14. The system of claim 11, wherein the stored payment information includes information about the refueling charge to be paid for a refueling amount selected through the payment screen and payment card information.

15. The system of claim 10, wherein the server is configured to approve payment for the refueling charge of the vehicle by confirming a refueling completion state of the vehicle from the service terminal when the payment for the refueling charge of the vehicle is performed.

16. A method of processing payment by a payment processing system including a vehicle terminal of a vehicle, a service terminal, and a server, the method comprising steps of:
transmitting, by the vehicle terminal, vehicle state information to the server when a refueling event corresponding to a preset condition occurs;
providing, by the server, filling station guide information to the vehicle terminal based on the vehicle state information;
storing, by the server, payment information for a refueling charge of a filling station received from the vehicle terminal, based on the filling station guide information; and
processing, by the server, payment for the refueling charge of the vehicle based on the stored payment information when a filling station arrival notification signal is received from the vehicle terminal.

17. The method of claim 16, wherein the step of transmitting the vehicle state information includes:
comparing a remaining fuel amount, which is an amount of fuel currently available in the vehicle, with a first fuel amount which is a lowest criterion and a second fuel amount based on a refueling pattern of a user; and
determining that the refueling event occurs when the remaining fuel amount of the vehicle is less than the first fuel amount or the second fuel amount.

18. The method of claim 16, further comprising steps of:
recognizing, by the server, vehicle information previously registered in a customer database; and
generating, by the server, the filling station guide information based on based on filling station payment history stored corresponding to the recognized vehicle.

19. The method of claim 16, further comprising steps of:
constructing, by the vehicle terminal, a payment screen for the refueling charge of the filling station based on the filling station guide information from the server and displaying the payment screen on a display; and
transmitting, by the vehicle terminal, payment information input through the payment screen to the server.

20. The method of claim 16, further comprising a step of:
approving, by the server, payment for the refueling charge of the vehicle by confirming a refueling completion state of the vehicle from the service terminal when the payment for the refueling charge of the vehicle is performed.
